(19) United States
(12) Patent Application Publication
(10) Pub. No.: US 2010/0064221 A1
(43) Pub. Date: Mar. 11, 2010

(54) METHOD AND APPARATUS TO PROVIDE MEDIA CONTENT

(75) Inventors: SCOTT WHITE, AUSTIN, TX (US); JAMES L. CANSLER, PFLUGERVILLE, TX (US); CHARLES SCOTT, AUSTIN, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T INTELLECTUAL PROPERTY I, L.P., RENO, NV (US)

(21) Appl. No.: 12/208,826

(22) Filed: Sep. 11, 2008

(51) Int. Cl. G06F 3/048

(52) U.S. Cl. 715/719

(57) ABSTRACT

Apparatus and methods to present visual displays are disclosed. In a particular embodiment, a method of providing media content is disclosed and includes identifying an available region of a video display. The available region includes a plurality of noncontiguous portions located outside of a first display region of the video display that is to display primary media content. The method also includes aggregating the plurality of noncontiguous portions to produce a second display region of the video display, the second display region including a contiguous portion that is to display secondary media content.

### FIELD OF THE DISCLOSURE

The present disclosure is generally related to visual displays.

### BACKGROUND

Media content to be displayed visually on a display device may be formatted in one of a plurality of aspect ratios. An aspect ratio is a ratio of width to height of a display. Media content that has been formatted in a first aspect ratio and is displayed on a screen having a second aspect ratio can result in portions of the screen being unused during the display of the media content. Or, if initial media content having a first aspect ratio is presented and is followed by presentation of subsequent media content having a second aspect ratio, portions of the display screen may be unused and available to display other media content during the presentation of the subsequent media content. In either of these scenarios, it would be advantageous to be able to efficiently utilize the available portions of the display screen.

### BRIEF DESCRIPTION OF THE DRAWINGS

FIG. 1 is a block diagram of a first embodiment of a system to provide media content;

FIG. 2 is a flow diagram of a first embodiment of a method to provide media content;

FIG. 3 is a flow diagram of a second embodiment of a method to provide media content;

FIG. 4 is a diagram of a first particular illustrative embodiment of a screen layout of a display screen to provide media content;

FIG. 5 is a diagram of a second particular illustrative embodiment of a screen layout of a display screen to present a media content; and

FIG. 6 is a diagram of a third particular illustrative embodiment of a screen layout of a display screen to provide media content.

### DETAILED DESCRIPTION

Apparatus and methods to present visual displays are disclosed. In a particular embodiment, a method of providing media content is disclosed and includes identifying an available region of a video display. The available region includes a plurality of noncontiguous portions located outside of a first display region of the video display that is to display primary media content. The method also includes aggregating the plurality of noncontiguous portions to produce a second display region that is contiguous, in which to display secondary media content.

In another particular embodiment, a method of providing media content from a video distribution network server includes determining, at the video distribution network server, that after an aspect ratio change from a first aspect ratio to a second aspect ratio, a display of primary media content at a first display region of a display device will result in an available region of the display device. The available region includes a plurality of noncontiguous portions outside of the first display region. The method also includes directing a set-top box to aggregate the plurality of noncontiguous portions to form a contiguous second display region.

In another particular embodiment, a set-top box device is disclosed and includes a processor and a memory. The memory includes a display module to output primary media content that is to be displayed in a first display region of a display device, and an aggregation module to aggregate a plurality of noncontiguous available display portions outside of the first display region forming a second contiguous display region of the display device.

In another particular embodiment, a computer-readable medium includes computer-executable instructions that when executed by a processor, cause the processor to identify an available region of a video display that includes a plurality of noncontiguous portions located outside of a first display region of the video display that is to display primary media content. The computer-executable instructions are further to aggregate the plurality of noncontiguous portions to produce a second contiguous display region to display secondary media content.

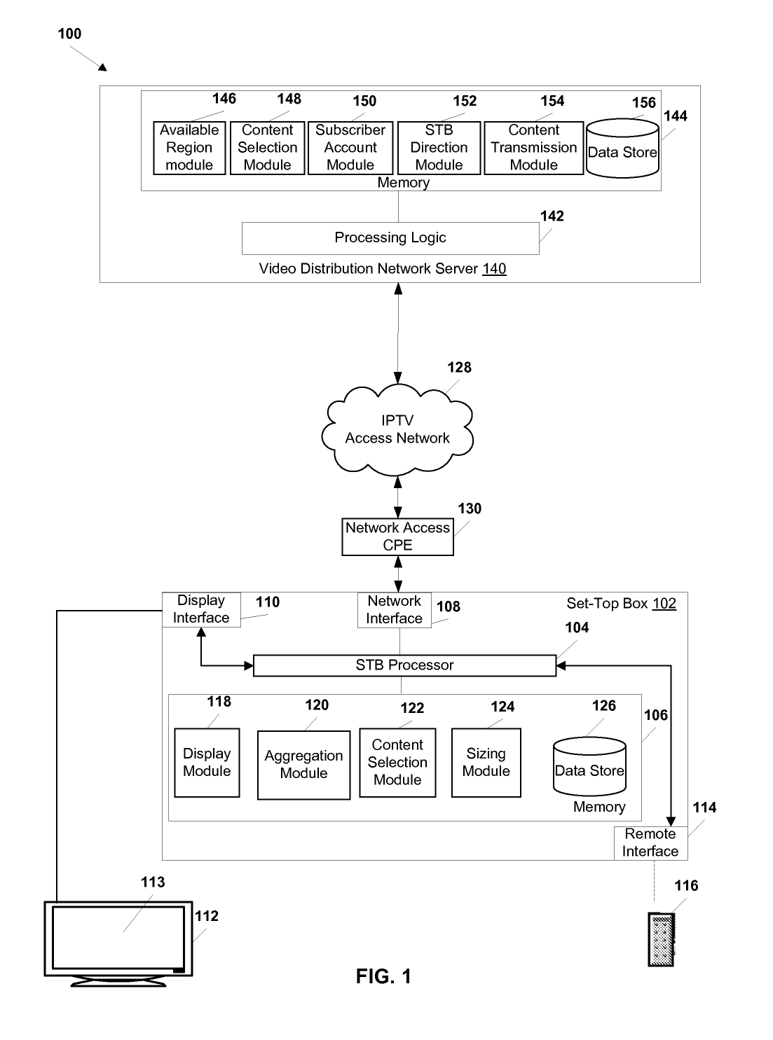

FIG. 1 depicts a first particular embodiment of a system to provide media content, and is generally designated 100. The system 100 includes a video distribution network server 140 connected to an Internet Protocol Television (IPTV) access network 128, which is coupled to a set-top box 102 via network access customer premises equipment (CPE) 130. The set-top box 102 is also coupled to a video display device 112 via a display interface 110, and coupled to a remote device 116 via a remote interface 114.

The video distribution network server 140 includes processing logic 142 and memory 144. The memory 144 includes an available region module 146, a content selection module 148, a subscriber account module 150, a set-top box direction module 152, a content transmission module 154, and a data store 156.

The set-top box 102 includes a network interface 108, a set-top box processor 104, a memory 106 coupled to the set-top box processor 104, the display interface 110 coupled to the set-top box processor 104, and the remote interface 114 coupled to the set-top box processor 104. The remote interface 114 may receive commands from the remote device 116 and transmit the received commands to the set-top box processor 104. The memory 106 includes a display module 118, an aggregation module 120, a content selection module 122, a sizing module 124, and a data store 126.

In a particular illustrative embodiment, the set-top box 102 receives media content from the video distribution network server 140 via the IPTV access network 128 and the network access CPE 130. The media content may be received by the network interface 108. The received media content may be visual media content intended to be displayed on a display device, such as the visual display device 112. The media content may include primary media content to be displayed in a first display region of the visual display device 112. In a particular illustrative embodiment, the media content may be initial primary media content having a first aspect ratio or subsequent primary media content having a second aspect ratio. The initial primary media content may occupy substantially all portions of a display screen 113 of the display device 112. For example, the initial primary media content may be a movie, a television show, an instructional video, or another visual presentation. The first aspect ratio of the initial primary media content may be one of 16:9, 4:3, 3:2, or another aspect ratio.

In a particular illustrative embodiment the set-top box 102 receives a notification that transmission of the subsequent primary media content is imminent, and that the second aspect ratio differs from the first aspect ratio. (Alternatively, the set-top box 102 may determine that the second aspect ratio differs from an aspect ratio of the display screen.) The set-top box 102 may determine that, when the subsequent primary media content is displayed on the display screen 113, the display screen 113 will have a plurality of blank regions. For example, if the initial primary media content has an aspect ratio of 16:9 and the subsequent primary media content to be displayed has an aspect ratio of 4:3, then when the subsequent primary media content is displayed on a first display region of display screen 113 there will unused (also called “available” herein) portions of the display screen 113, i.e., portions of unused display pixels. In a particular embodiment, the set-top box 102, executing instructions residing in the aggregation module 120 of the memory, rearranges relative locations of the available portions to form a second display region of the display screen 113 that is contiguous and that will display secondary media content.

The set-top box 102 may execute instructions in the display module 118 causing subsequent primary media content to be displayed in the first display region, which is displaced from a geometric center of the display screen 113. For example, the first display region may occupy an upper portion of the display screen 113. The second display region of the display screen 113 may occupy a lower portion of the display screen 113.

By executing instructions in the sizing module 124, the set-top box processor 104 can determine a size of the second display region. By executing instructions in the content selection module 122, the set-top box processor 104 may select secondary media content to be displayed in the second display region. Various factors can influence secondary media content selection, and may include size and layout of the second display region, subject matter of the primary media content to be displayed in the first display region, user preferences that may include the user interests, entertainment format of the secondary media content (e.g., animation, talking heads, etc.), need for closed-captioning, user interest in commentary related to on the primary media content to be displayed, user tendency to multitask, and/or other factors.

The set-top box 102 may supply secondary media content to the display device 112 to be displayed within the second display region. The secondary media content may be retrieved from the data store 126, or may be received from the video distribution network server 140, or from another source.

In a particular illustrative example, the secondary media content to be displayed may include advertising content. In a particular illustrative example, the user may be rewarded for receiving the advertising content. For example, the user may be provided a credit against a cost of delivery of the initial primary media content or the subsequent primary media content, discounts, access to additional media content, other benefits, or any combination thereof.

In another particular illustrative embodiment, the video distribution network (VDN) server 140 may determine that the first aspect ratio associated with the initial primary media content being sent via the IPTV access network 128 differs from the second aspect ratio associated with the subsequent primary media content to follow. (Alternatively, the VDN server 140 may determine that the second aspect ratio differs from the width-to-height ratio of the display screen 113.) By executing instructions residing in the available region module 146, the processing logic 142 may determine that display of the subsequent primary media content will result in a plurality of available noncontiguous display portions lying outside of a first display region of the display screen 113. The first display region may be reserved to display the subsequent primary media content. The processing logic 142 executes additional instructions residing in the available region module 146 to aggregate the available display portions of the display screen 113, forming the second display region that will present secondary media content.

The processing logic 142 may determine the secondary media content to be displayed in the second display region of the display screen 113 by executing instructions residing in the content selection module 148. Selection may be based on factors that can include a size of the second display region, corresponding subject matter of the primary media content to be presented in the first display region, a user profile containing various user preferences including knowledge of the user demographic and the user taste, advertising materials, other factors, or any combination thereof.

In a particular illustrative embodiment, the VDN server 140 determines that certain advertising material is of potential interest to a subscriber. In a particular illustrative embodiment, the VDN server receives permission from the subscriber to provide the advertising material to be displayed. The VDN server 140, executing instructions residing in a subscriber account module 150 of the memory 144, notes in a subscriber account that advertising material is being sent to the set-top box 102. In a particular illustrative embodiment, the subscriber accrues credits recorded in the subscriber account as an incentive for receiving the advertising material. The accrued credits may partially offset a cost associated with receiving the initial primary media content or the subsequent primary media content, or may pay for access to additional media content, may pay for other benefits, or any combination thereof.

In a particular illustrative embodiment, by executing instructions in the set-top box direction module 152 the VDN server 140 alerts the set-top box 102 of an impending change of content from the initial primary media content to subsequent primary media content that is to be displayed in the first display region of the display screen 113. Prior to sending the subsequent primary media content the set-top box 102 rearranges the layout of the display screen 113 by aggregating available portions, forming a contiguous second display region. The first display region is typically larger and more centrally located on the display screen 113 than the second display region.

The second display region can display secondary media content while the first display region displays the subsequent primary media content. The VDN server 140, executing instructions residing in the content transmission module 154, sends secondary media content to be displayed in the second display region. The secondary media content may be retrieved from the data store 156 of the VDN server 140, or may be retrieved from another media content source (not shown), or any combination thereof.

In a particular illustrative embodiment, the secondary media content to be displayed in the second display region pertains directly to subject matter of the subsequent primary media content displayed in the first display region. For example, the secondary media content may include critical commentary, closed-captioning, advertising of related products or services, other information related to the subsequent primary media content, or any combination thereof. In another particular illustrative example, the secondary media content to be displayed is unrelated to the subsequent primary media content. In yet another particular illustrative embodiment, the secondary media content is user selected, influenced by known user factors, selected based on a known user profile, or any combination thereof. In another particular illustrative embodiment, the secondary media content includes advertisements that are related to the subsequent primary media content. In another particular illustrative embodiment, the secondary media content includes advertisements that are unrelated to the subsequent primary media content, or that are selected based other factors, or any combination thereof. In a particular illustrative embodiment, user input regarding secondary media content to be displayed is received from the remote device 116, or from another user input device via the remote interface 114.

In another particular illustrative embodiment, interim media content may be presented during a “switchover” time period from a first aspect ratio to a second aspect ratio. The interim media content may be related to the subsequent primary media content, or may be unrelated to the subsequent primary media content. For example, the interim media content can be an animated short presentation, a countdown clock, or another indication of a time delay between primary media content presentations. The interim media content may be displayed in the first display region, the second display region, or in both the first display region and the second display region.

A VDN service provider may choose to offer credits, rebates or other incentives for a user willing to watch advertising material, provide feedback on a pilot presentation or another presentation of the network's choosing. In another particular illustrative embodiment, the user may elect to pay a surcharge in order to receive secondary media content of the user's choosing. For example, the user may elect to have media content of a special interest to the user, such as financial reports, delivered as secondary media content. In another particular illustrative embodiment, the user may elect to utilize the second display region to check email, to access Internet resources (e.g., “to surf the web”) or to engage in other interactive activities.

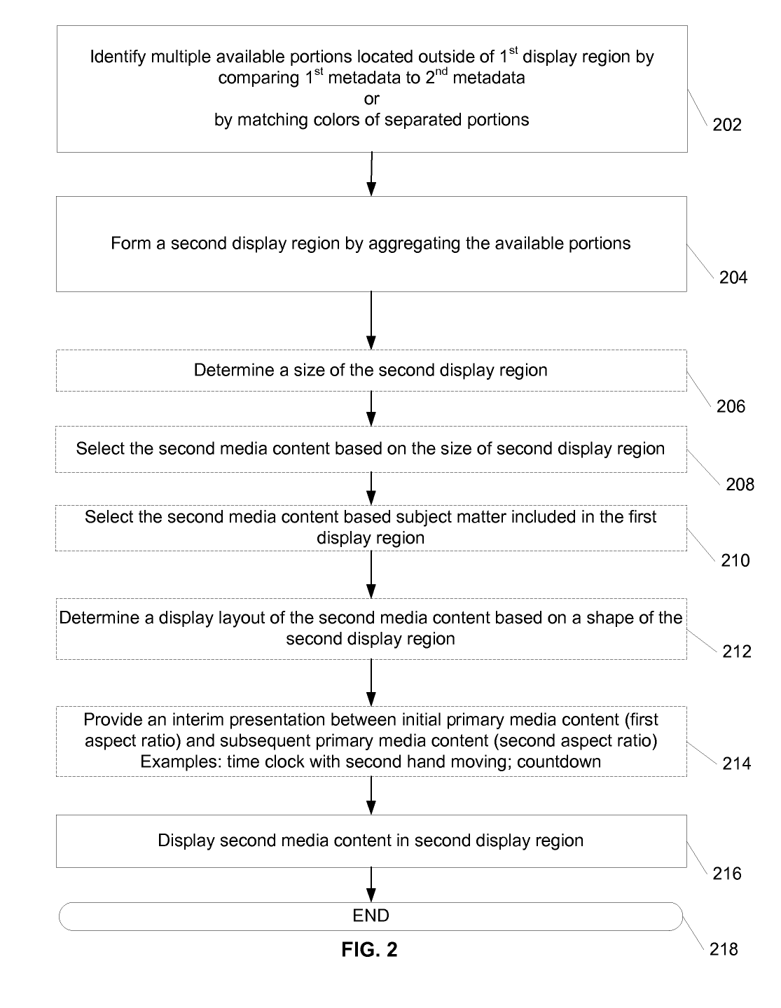

FIG. 2 depicts a particular embodiment of a method of providing media content. At block 202, the method includes determining whether there will be available portions of a display screen. Available portions may be predicted by comparing a first aspect ratio associated with initial primary media content to a second aspect ratio associated with subsequent primary media content. The first aspect ratio may be extracted from first metadata associated with the initial primary media content, and the second aspect ratio may be extracted from second metadata associated with subsequent primary media content. When a difference is detected between the first aspect ratio and the second aspect ratio, the method determines that there will be available portions when the subsequent primary media content is displayed in the first display region. Alternatively, at the start of display of the subsequent primary media content an available portion of the display screen situated outside of the first display region can be identified by detecting a uniform pixel color throughout the portion. Available portions may each have a substantially uniform color, such as grey, black or another color, indicating non-use of the portion. Other techniques may also be used to determine whether a plurality of available portions will exist after a change from the first aspect ratio to the second aspect ratio.

Moving to block 204, a second display region is formed by aggregating the available portions. For example, the first region can be moved up and to the left of the display screen so that substantially all available portions are contiguous and lie along the bottom and the right side of the display screen. Proceeding to block 206, optionally a size of the second display region is determined. The size may be expressed as a pixel count, or another measure of size. Optionally, a shape of the second display region may be determined, such as horizontal rectangle, vertical rectangle, L-shaped, or another shape. Moving to block 208, optionally secondary media content can be selected based on the size of the second display region. Moving to block 210, optionally the second media content can be selected based on subject matter to be presented in the first display region. Moving to block 212, optionally a display layout of the second media content may be based on the shape of the second display region. Proceeding to block 214, optionally an interim presentation is provided to be displayed between an initial primary media content display and a subsequent primary media content display. The interim presentation may be displayed in the first display region or in the second display region, or in a combination thereof. In a particular illustrative embodiment, interim presentations include a time clock with second hand moving, a countdown, or another form of timekeeping. Alternatively, the interim presentation may be a cartoon, an entertaining short presentation, another presentation, or any combination thereof. Proceeding to block 216, the secondary media content is displayed in the second display region. The method terminates at 218.

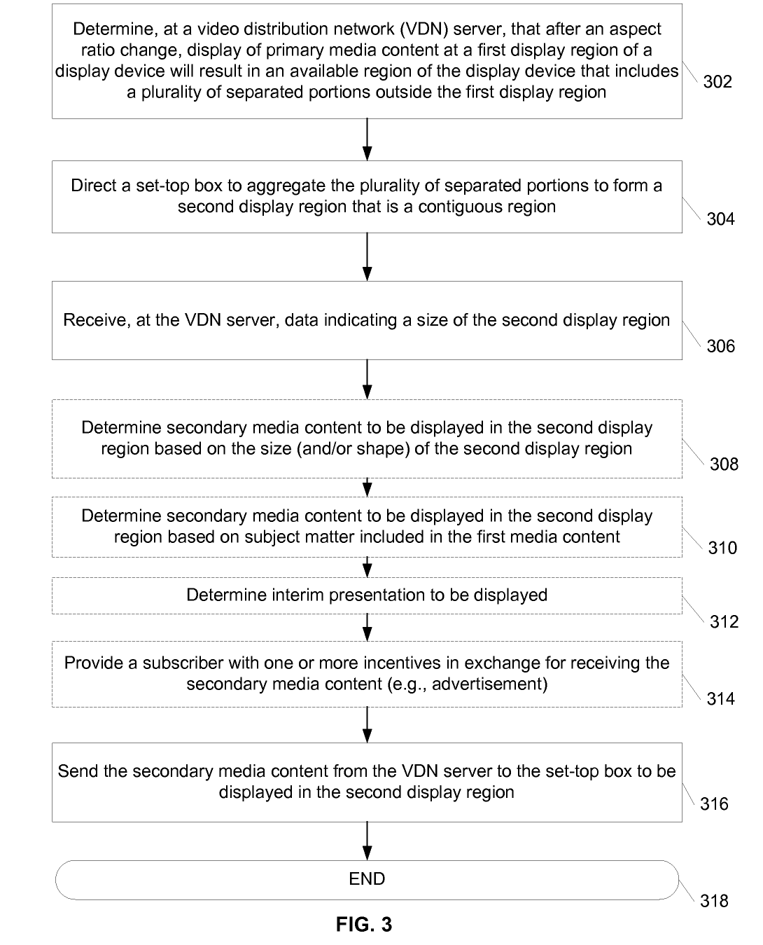

FIG. 3 depicts a second particular embodiment of a method to present media content. At block 302, a VDN server determines that after an aspect ratio change, display of primary media content at a first display region of a display screen will result in an available region of the display screen that includes a plurality of available portions that are noncontiguous, and that reside outside of the first display region. Moving to block 304, a set-top box is directed by the VDN server to aggregate the plurality available portions to form a second display region that is contiguous. Proceeding to block 306, the VDN server receives data indicating a size of the second display region, such as a pixel count. Advancing to block 308, optionally secondary media content to be displayed in the second display region is determined based at least in part on the size of the second display region, or is based at least in part on the shape of the second display region, or based on a combination of size and shape. Moving to block 310, optionally the VDN server determines secondary media content to be displayed in the second display region, based at least in part on subject matter included in the primary media content. At block 312, optionally the VDN server determines an interim presentation to be displayed during the change from a first aspect ratio (associate with display of initial primary media content display) to a second aspect ratio (associated with display of subsequent primary media content). The interim presentation may be based at least in part on a user profile, based on user input, or based on other factors. In a particular illustrative embodiment, the interim presentation may include a default presentation. Advancing to block 314, optionally a user is provided with one or more incentives in exchange for receiving the secondary media content. For instance, if the secondary media content is an advertisement, the user may be provided with an incentive such as credits toward a cost of receiving the primary media content or the subsequent primary media content, discounts, access to additional media content, other benefits, or any combination thereof. Proceeding to block 316, the VDN server may send the secondary media content to the set-top box to be displayed in the second display region. The method terminates at 318.

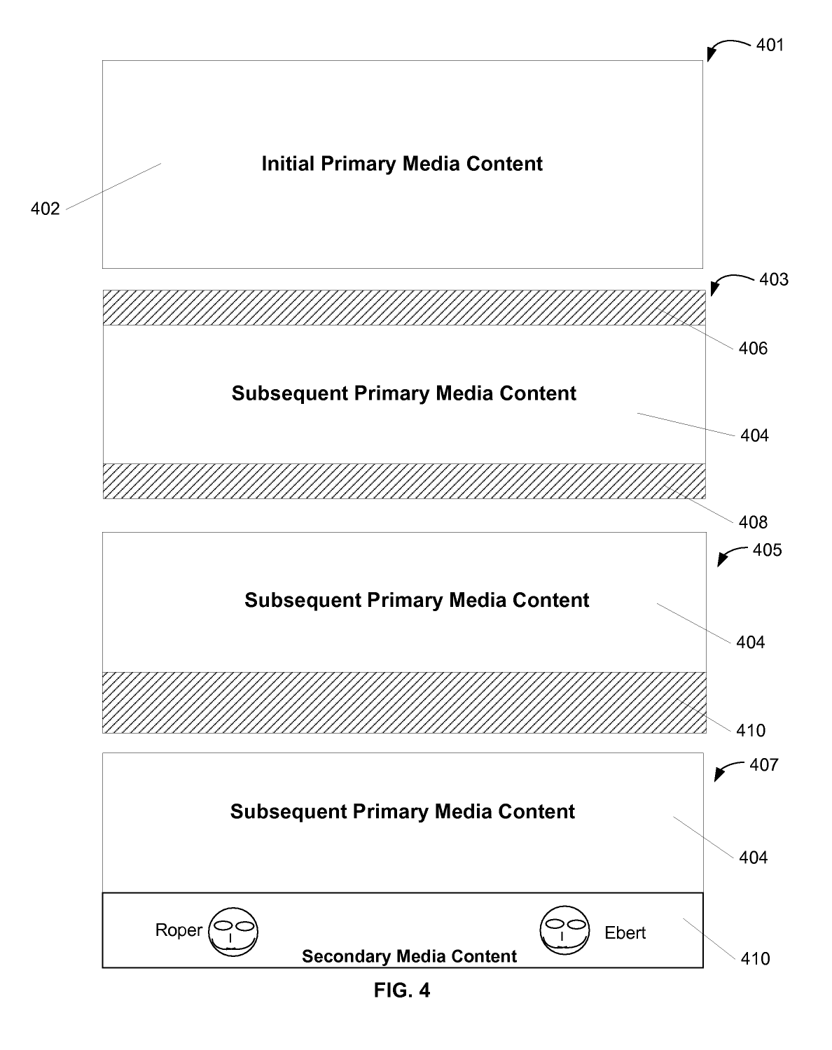

FIG. 4 depicts a particular illustrative embodiment of a screen layout of a display screen to present media content. At Screen 401, a display screen 402 presents initial primary media content that has a first aspect ratio. In a particular illustrative example, the display screen 402 has a screen aspect ratio that is the same as the first aspect ratio and presentation of the initial primary media content consumes substantially all portions of the screen. Subsequent primary media content to be presented has a second aspect ratio. Screen 403 includes a first display region 404 to display the subsequent primary media content with the second aspect ratio. Because the second aspect ratio differs from the screen aspect ratio, the screen 403 includes two noncontiguous available portions 406, 408 of unused pixels. In screen 405, the subsequent primary media content is presented in a first display region 404 and a second display region 410 is established that aggregates portions 406 and 408. That is, the first visual display region 404 has been relocated to an upper portion of the screen 405 and the noncontiguous portions 406 and 408 have been aggregated to form the second display region 410. The second display region 410 is contiguous and occupies a lower portion of the screen 405. At screen 407, subsequent primary media content is displayed in the first display region 404, while secondary media content is displayed in the second display region 410. In a particular illustrative example, the secondary media content includes commentary presented by “talking heads,” illustrated in FIG. 4 as “Roper” and “Ebert.” In a particular illustrative example, the commentary is related to subject matter presented in the first display region 404. In another particular illustrative example, the secondary media content is user selected, or is influenced by known user factors, or is selected based on a known user profile, or any combination thereof. In another particular illustrative embodiment, the secondary media content includes advertisements that are related to the primary media content, or are unrelated to the primary media content, or are selected based other factors, or any combination thereof.

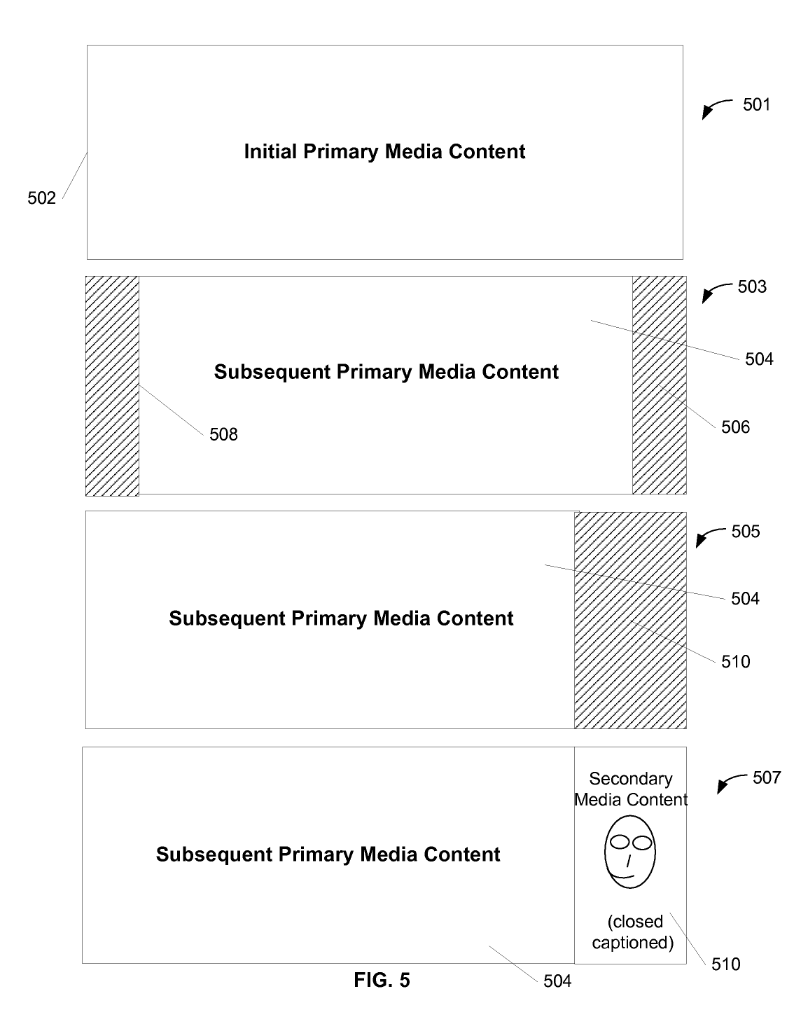

FIG. 5 is a diagram of a second particular illustrative embodiment of a screen layout of a display screen to present media content. Screen 501 depicts a first layout of a display screen 502. The display screen 502 has a display screen aspect ratio that matches a first aspect ratio associated with an initial primary media content. That is, the initial primary media content encompasses substantially the entire screen 501. At screen 503, subsequent primary media content having a second aspect ratio is displayed in a first display region 504. The first display region 504 is flanked on either side by available display portions 506 and 508 that are noncontiguous with each other. At screen 505, the noncontiguous display portions 506 and 508 have been aggregated to form a contiguous second display region 510 occupying a rightmost portion of the screen 505. The first display region 504 has been shifted to a leftmost position of the screen 505. Screen 507 shows the subsequent primary media content displayed in the first display region 504 and secondary media content being displayed in the second display region 510. Optionally, the secondary media content may include close-captioning of the primary media content, other secondary media content. In another particular illustrative example, the secondary media content is user selected, or is selected based at least in part on known user-related factors, selected based on a known user profile, or any combination thereof. In another particular illustrative embodiment, the secondary media content includes advertisements that are related to the primary media content or that are unrelated to the primary media content, or that are selected based other factors, or any combination thereof.

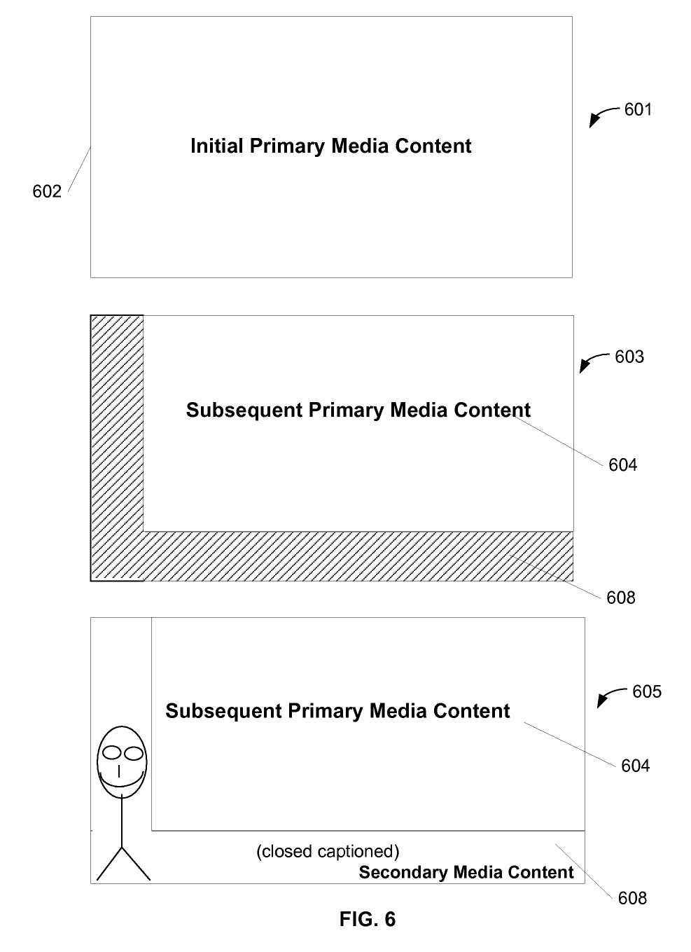

FIG. 6 is a diagram of a third particular illustrative embodiment of a screen layout of a display screen to present media content. Screen 601 depicts a first layout of a display screen 602. The display screen 602 has a display screen aspect ratio that matches a first aspect ratio of an initial primary media content. The initial primary media content display covers substantially the entire screen 601. At screen 603, subsequent primary media content, having a second aspect ratio, is displayed in a first display region 604. The first display region 604 occupies an upper right portion of the display screen, leaving a contiguous second display region 608 that is L-shaped.

Screen 605 shows the subsequent primary media content displayed in the first display region 604 and secondary media content being displayed in a second display region 608. Optionally, the secondary media content may include close-captioning of the primary media content, other secondary media content. In another particular illustrative example, the secondary media content is user selected, or is selected based at least in part on known user-related factors, or is selected based on a known user profile, or any combination thereof. In another particular illustrative embodiment, the secondary media content includes advertisements that are related to the primary media content or unrelated to the primary media content or selected based other factors, or any combination thereof.

In any of the embodiments disclosed herein, secondary media content selected to be displayed may include supplemental video content, picture content, a banner, text, symbols, advertisements, or any combination thereof. In another particular illustrative embodiment, the second display region adjoins the first display region. In another particular illustrative embodiment the second display region is spaced from the first display region by an intervening gap of unused blank pixels. In another particular illustrative embodiment, the secondary media content includes weather information, news, financial information, other topical or timely information, or any combination thereof. In another particular illustrative embodiment, the secondary media content includes viewer-generated media content. The viewer-generated media content may include pictures, short video sequences, extended video sequences, and interactive capability such as text messaging, instant messaging, other interactive forms of communication, or any combination thereof.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software executable by a computer system. The software may reside in a computer-readable medium. While the computer-readable medium may be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing media content, the method comprising:
identifying an available region of a video display, the available region comprising a plurality of noncontiguous portions located outside of a first display region of the video display, the first display region to display primary media content; and
aggregating the plurality of noncontiguous portions to produce a second display region of the video display, the second display region comprising a contiguous portion, the second display region to display secondary media content.

2. The method of claim 1, wherein aggregating the plurality of noncontiguous portions occurs in connection with a switch from a first presentation of initial primary media content having a first aspect ratio to a second presentation of subsequent primary media content having a second aspect ratio.

3. The method of claim 2, wherein identifying the available region further comprises interpreting first metadata associated with the initial primary media content to determine the first aspect ratio, and interpreting second metadata associated with the subsequent primary media content to determine the second aspect ratio.

4. The method of claim 2, further comprising providing an interim presentation during the switch from the initial primary media content to the subsequent primary media content.

5. The method of claim 1, wherein identifying the available region further comprises identifying two of the noncontiguous portions, each of which comprises pixels of substantially a same color.

6. The method of claim 1, wherein aggregating further comprises relocating the first display region from a first display location to a second display location.

7. The method of claim 6, wherein the second display location includes a corner of the video display.

8. The method of claim 1, further comprising selecting the secondary media content based at least in part on a size associated with the second display region.

9. The method of claim 1, further comprising selecting the secondary media content based at least in part on a shape associated with the second display region.

10. The method of claim 1, wherein the available region includes a substantially vertically oriented rectangular portion.

11. The method of claim 1, wherein the available region includes a substantially horizontally oriented rectangular portion.

12. The method of claim 1, further comprising selecting the secondary media content, wherein subject matter included in the secondary media content is associated with subject matter included in the subsequent primary media content.

13. The method of claim 1, wherein the secondary media content includes supplemental video content, picture content, a banner, text, symbols, advertisements, or any combination thereof.

14. The method of claim 1, wherein the method is performed at a set-top box.

15. The method of claim 1, wherein the second display region adjoins the first display region.

16. A method of providing media content from a video distribution network server, the method comprising:
determining, at the video distribution network server, that after an aspect ratio change from a first aspect ratio to a second aspect ratio, a display of primary media content at a first display region of a display device will result in an available region of the display device, the available region comprising a plurality of noncontiguous portions outside of the first display region; and
directing a set-top box to aggregate the plurality of noncontiguous portions to form a second display region comprising a contiguous region.

17. The method of claim 16, further comprising:
receiving, at the video distribution network server, data indicating a size of the second display region; and
determining, at the video distribution network server, secondary media content to be displayed in the second display region based at least in part on the size of the second display region.

18. The method of claim 16, further comprising sending secondary media content from the video distribution network server to the set-top box, the secondary media content to be displayed in the second display region.

19. The method of claim 18, further comprising providing a subscriber with one or more incentives in exchange for receiving the secondary media content to be displayed in the second display region.

20. A set-top box device comprising:
a processor; and
a memory, the memory including:
a display module to output primary media content to be displayed in a first display region of a display device; and
an aggregation module to aggregate a plurality of noncontiguous available display portions outside of the first display region to form a second display region of the display device, wherein the second display region comprises a single contiguous area.

21. The set-top box device of claim 20, further comprising a content selection module to select secondary media content to be displayed within the second display region.

22. The set-top box device of claim 21, wherein the display module is further to output the secondary media content to be displayed within the second display region.

23. A computer-readable medium comprising computer-executable instructions that when executed by a processor, cause the processor to:
identify an available region of a video display, the available region comprising a plurality of noncontiguous portions located outside of a first display region of the video display, the first display region to display primary media content; and
aggregate the plurality of noncontiguous portions to produce a second display region comprising a single contiguous portion, the second display region to display secondary media content.

24. The computer-readable medium of claim 23, wherein the secondary media content includes an advertisement, weather, news, or financial information.

25. The computer-readable medium of claim 23, wherein the secondary media content includes user generated content.
